(19) United States
(12) Patent Application Publication
(10) Pub. No.: US 2007/0153734 A1
(43) Pub. Date: Jul. 5, 2007

(54) Apparatus and method for transparent relay in multihop relay broadband wireless access (BWA) communication system

(75) Inventors: Mi-Hyun Lee, Seoul (KR); Jae-Weon Cho, Suwon-si (KR); Jeong-Ho Park, Seoul (KR); Song-Nam Hong, Seoul (KR); Pan-Yuh Joo, Seoul (KR); Joon-Young Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/649,153

(22) Filed: Jan. 3, 2007

(30) Foreign Application Priority Data
Jan. 3, 2006 (KR) 2006-0000697

(51) Int. Cl. H04Q 7/00

(52) U.S. Cl. 370/329; 370/338

(57) ABSTRACT

An apparatus and method of transparently relaying a signal in a direct link and a relay link using the same frequency band in a multihop relay Broadband Wireless Access (BWA) communication system. The method includes designating a start point of an asynchronous frame of the relay link by taking into account of a broadcast channel transmission interval of the direct link frame; and making a frame interval of the relay link null, where a transmission (Tx) mode of the direct link overlaps with another Tx mode. Accordingly, serving cell service coverage expansion and backward compatibility are achieved and a frame is constructed by selecting an optimum frame interval according to system information of the serving cell service. Therefore, efficient wireless access service can be provided.

### CROSS-REFERENCE TO RELATED APPLICATION

This application claims priority under 35 U.S.C. § 119 to an application filed in the Korean Intellectual Property Office on Jan. 3, 2006 and assigned Ser. No. 2006-697, the contents of which are incorporated herein by reference.

### BACKGROUND OF THE INVENTION

1. Field of the Invention

The present invention relates generally to a multihop relay Broadband Wireless Access (BWA) communication system, and in particular, to an apparatus and method of supporting a direct link or a relay link using the same frequency in a multihop relay BWA communication system.

2. Description of the Related Art

In fourth-generation (4G) mobile communication systems, cells having a very small radius are located to enable rapid communications and accommodate more traffic. However, it may be impossible to achieve a centralized design using current wireless network design schemes. A wireless network should be controlled and deployed in a distributed manner and actively adapt to environment changes, such as joining of a new base station. To these ends, 4G mobile communication systems are configured as autonomous adaptive wireless networks.

It would be necessary to adopt techniques applied to an ad-hoc network to a mobile communication system for substantial implementation of an autonomous adaptive wireless network for a 4G mobile communication system. A representative example is a multihop relay cellular network, in which a multihop relay scheme applied to an ad-hoc network is introduced to the cellular network configured with a fixed base station. In a BWA communication system, since communications are conducted through one direct link between a base station and a mobile station, it is easy to establish a highly reliable radio communication link between the base station and the mobile station.

However, since a network configuration has low flexibility because of a fixed base station, it is hard to provide efficient services in a radio environment, which is subject to severe change in traffic distribution or required traffic. To overcome this shortcoming, it is possible to apply a relay scheme, which delivers data in a multihop manner by use of neighboring mobile stations or relay stations. The multihop relay scheme can provide a mobile station with a radio channel of better channel status by building a multihop relay path by way of a repeater which is placed between the base station and the mobile station. Furthermore, a high speed data channel can be provided to mobile stations which cannot communicate with the base station in a shadow area, by means of the multihop relay path, to thereby expand the cell area.

FIG. 1 shows a general multihop relay cellular network. A Mobile Station (MS) 110 in a service area 101 of a Base Station (BS) 100 is connected to BS 100 through a direct link. In contrast, an MS 120 with poor channel status, which resides outside the service area 101 of BS 100, is connected to a relay link via a Relay Station (RS) 130.

When MSs 110 and 120 suffer poor channel status because they are outside the service area 101 of B S 100 or in a shadow area under the severe shielding by buildings, BS 100 is able to provide better radio channels to MSs 110 and 120 by means of RS 130. Accordingly, by adopting the multihop relay scheme, BS 100 can provide high speed data channel in the boundary area of poor channel status and expand the cell service area.

In further detail, the RS 130 receives a downlink (DL) signal from the BS 100 and relays the received signal to the second MS 120. Also, the RS 130 receives an uplink (UL) signal from the second MS 120 and relays the received signal to the BS 100. Accordingly, the multihop relay cellular network has the BS-RS link between the BS 100 and the RS 130, the RS-MS link between the RS 130 and the second MS 120, and the BS-MS link between the BS 100 and the first MS 110. Each link is divided to the UL link and the DL link based on the end of the data transmission path.

In the BWA communication system, information is transmitted and received between the BS and the MS through the direct link using a frame as shown in FIG. 2. FIG. 2 shows a Time Division Duplex (TDD) frame structure provided by Institute of Electrical and Electronics Engineers (IEEE) 802.16, by way of example, for transceiving information between the BS and the MS. The TDD frame is divided to a DL subframe 201 and a UL subframe 203. A Transmit/Receive Transition Gap (TTG) 205, which is a guard region, is inserted between the DL subframe 201 and the UL subframe 203. A Receive/Transmit Transition Gap (RTG) 207 is inserted between the frames.

The DL subframe 201 broadcasts a preamble and common control information in a fixed region, that is, in a mandatory slot to the cell service area. The preamble and the common control information should be broadcast in the fixed region of the frame so an MS belonging to the service coverage of the BS can receive the broadcast preamble and common control information and acquire synchronization and control information for its operation.

As discussed above, when providing a relay service in a multihop relay BWA communication system, to maintain backward compatibility, what is needed is a function for executing communication using an RS without additional function at an MS.

### SUMMARY OF THE INVENTION

An aspect of the present invention is to substantially solve at least the above problems and/or disadvantages and to provide at least the advantages below. Accordingly, an aspect of the present invention is to provide an apparatus and method for transparent relay using one frequency band in a multihop relay BWA communication system.

Another aspect of the present invention is to provide a frame construction method for asynchronous transparent relay using one frequency band in a multihop relay BWA communication system, and its supporting method.

A further aspect of the present invention is to provide an apparatus and method of rejecting interference occurring when a direct link and a relay link perform asynchronous transparent relay using the same frequency band in a multihop relay BWA communication system.

The above aspects are achieved by providing a subframe construction method of supporting a relay service using one frequency band in a multihop relay BWA communication system, which includes constructing a direct link subframe to communicate in a direct link between a BS and an RS or an MS during a first interval of the subframe; and constructing a direct link subframe to communicate in a direct link between the BS and an MS, and a relay link subframe to communicate in a relay link between the RS and an MS during a second interval of the subframe.

According to one aspect of the present invention, a method of supporting a relay service using one frequency band at a BS in a multihop relay BWA communication system, includes setting a direct link frame interval for providing service to one of an RS and an MS in a direct link; designating a start point of a relay link frame by taking into account a Broadcast Channel (BCH) transmission interval in the direct link frame; sending start point information of the relay link frame to the RS; and communicating with one of the RS and an MS according to the direct link frame construction scheme.

According to another aspect of the present invention, a frame construction method of supporting a relay service using one frequency band in a multihop relay BWA communication system, includes constructing a direct link subframe for a BS to send a signal to one of an RS and an MS in a direct link during a first interval of the frame; constructing a relay link subframe for the RS to send a signal to the MS in a relay link during a second interval of the frame; constructing a direct link subframe for the BS to send a signal to the MS in a direct link during a third interval of the frame; constructing a direct link subframe for one of the RS and the MS to send a signal to the BS in a direct link during a fourth interval of the frame; and constructing a relay link subframe for the MS to send a signal to the RS in a relay link during a fifth interval of the frame.

According to a further aspect of the present invention, a method of supporting a relay service using one frequency band at a BS of a multihop relay BWA communication system, includes setting a direct link frame interval for communicating with one of an RS and an MS in a direct link; constructing a frame by time-dividing the frame interval to a certain number of intervals and allocating the intervals to a direct link frame or a relay link frame; and sending the frame construction information to the RS and the MS.

According still another aspect of the present invention, an apparatus for supporting a relay service using one frequency band at a BS in a multihop relay BWA communication system, includes a time slot divider for calculating a length of a time slot according to a frame length, a ratio of an uplink (UL) interval to a downlink (DL) interval, a ratio of a direct link service interval to a relay link service interval, and a number of time slots; a timing controller for providing a timing signal to transmit and receive a signal according to the calculated length of the time slot; a transmitter for sending a signal of a corresponding frequency band according to the timing signal; and a receiver for receiving a signal of a corresponding frequency band according to the timing signal.

### BRIEF DESCRIPTION OF THE DRAWINGS

The above and other objects, features and advantages of the present invention will become more apparent from the following detailed description when taken in conjunction with the accompanying drawings in which:

FIG. 1 depicts a configuration of a general multihop relay BWA system;

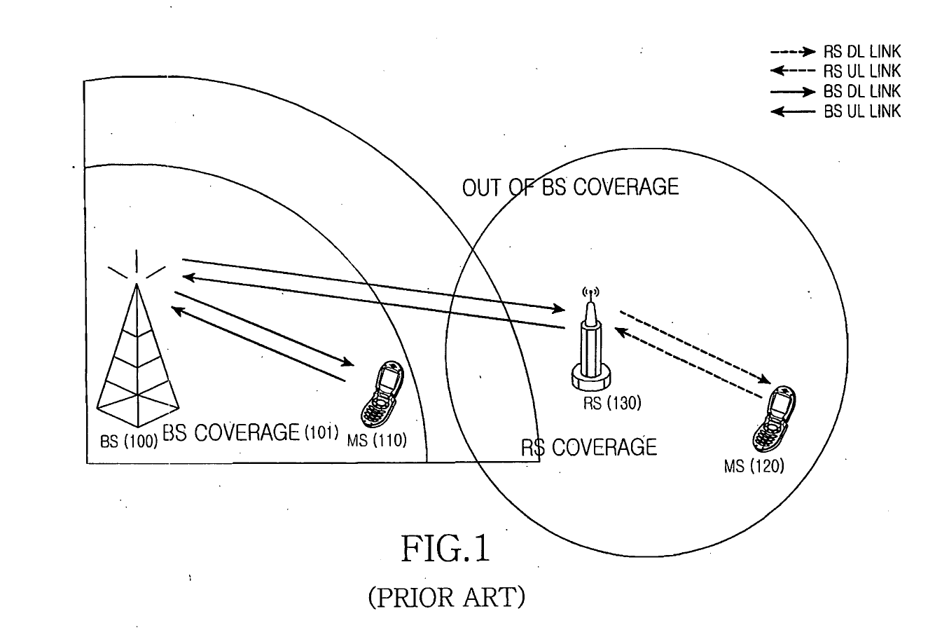

FIG. 2 depicts a frame structure of a general BWA system;

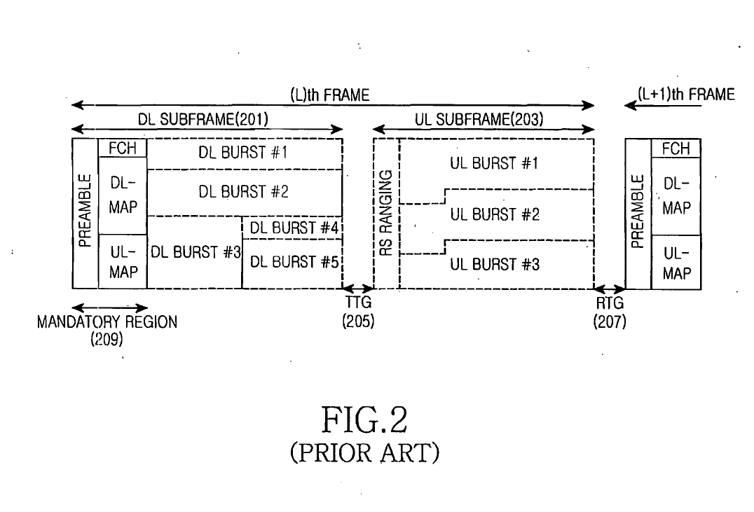

FIG. 3 depicts a configuration of a multihop relay BWA communication system for transparent relay using one frequency band according to the present invention;

FIG. 4 is a simplified diagram of a serving cell frame and a relay cell frame for asynchronous relay according to the present invention;

FIG. 5 depicts a structure of the serving cell frame and the relay cell frame for the asynchronous relay using a space division multiplexing according to the present invention;

FIG. 6 is a flowchart outlining an operation of a BS for the asynchronous relay using the space division multiplexing according to the present invention;

FIG. 7 is a simplified diagram of a serving cell frame and a relay cell frame for asynchronous relay using a time division multiplexing according to the present invention;

FIG. 8 is a simplified diagram of the serving cell frame which is divided to time slots to maintain UL/DL transmission efficiency of the serving cell frame according to the present invention;

FIG. 9 is a flowchart outlining an optimum time slot selection procedure when constructing the serving cell frame by dividing to time slots according to the present invention;

FIG. 10 depicts a structure of a serving cell frame and a relay cell frame for asynchronous relay by dividing to time slots according to the present invention; and

FIG. 11 is a block diagram of a BS which schedules the serving cell frame and the relay cell frame according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention suggests a technique for supporting a relay service using the same frequency band at a direct link and a relay link in a multihop relay Broadband Wireless Access (BWA) communication system. While a Time Division Duplex (TDD) and Orthogonal Frequency Division Multiplexing Access (OFDMA) wireless communication system are described below, the present invention is applicable to other multiple access schemes. A frame provided in a direct link of a Base Station (BS) is referred to as a serving cell frame, and a frame provided in a relay link of a Relay Station (RS) is referred to as a relay cell frame.

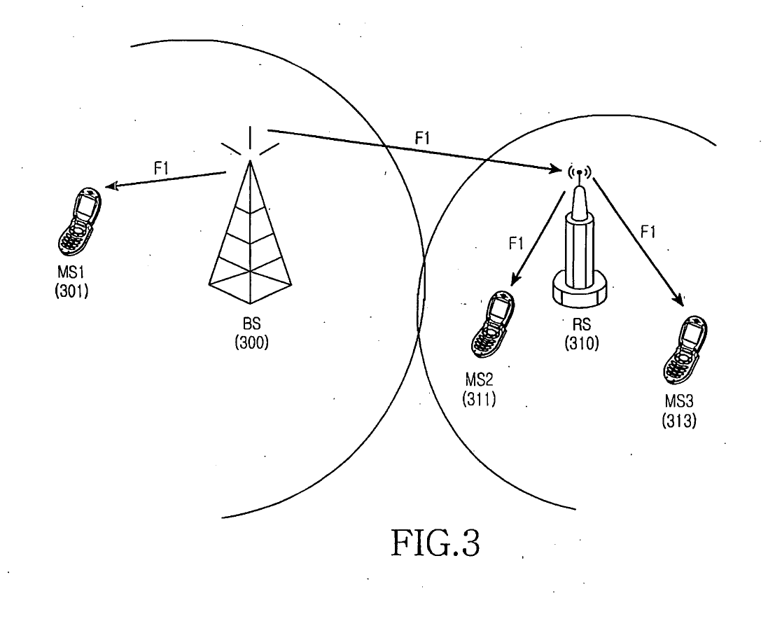

FIG. 3 shows a multihop relay BWA communication system for transparent relay according to the present invention. In the following explanation, it is assumed that signals are transparently relayed using one frequency band based on 2-hop relay scheme.

As shown in FIG. 3, a Mobile Station (MS) 301 belonging to a service coverage of a BS 300 is connected to the BS 300 through a direct link, whereas MSs 311 and 313 out of the service coverage of the BS 300 are connected to the BS 300 through a relay link via an RS 310.

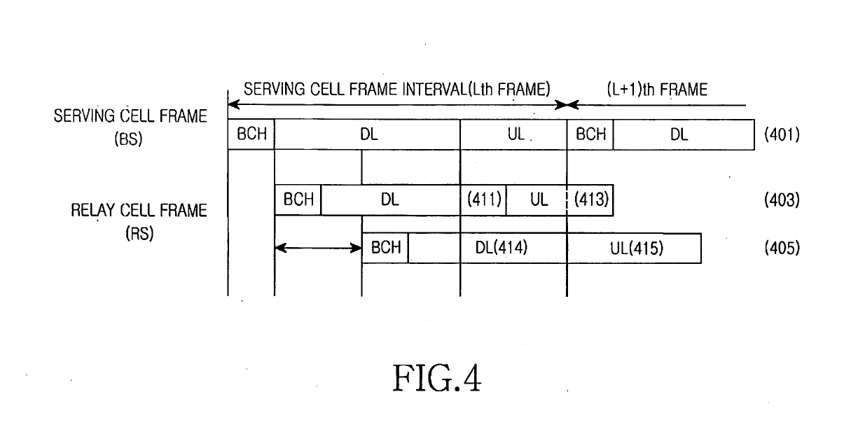

That is, the BS 300 communicates with the MS 301, and communicates with the MS 311 and 313 via the relay station 310. To perform the transparent relay using one frequency band, the BS 300 schedules so the RS 310 asynchronously transmits a relay cell frame as shown in FIG. 4. The BS 300 controls the operation of the RS 310 through a control channel of the BS-RS link.

The RS 310 selects only relay-requiring signals from the signals received from the BS 300. Next, the RS 310 relays the selected signals to the MSs 311 and 313. At this time, the RS 310 selects the relay-requiring signals under the control of the BS 300. Also, under the control of the controller 300, the RS 310 transmits and receives a relay cell frame in asynchrony to the BS frame to perform the transparent relay using one frequency.

FIG. 4 shows a serving cell frame and a relay cell frame for asynchronous relay according to the present invention. In the following explanation, it is assumed that the downlink (DL) interval and the uplink (UL) interval have specific sizes within the frames.

As shown in FIG. 4, in a multihop relay BWA communication system, the direct link and the relay link use one frequency band. Hence, the BS asynchronously transmits the serving cell frame 401 and the relay cell frame 403 to support the relay service while avoiding RF isolation problem.

When the asynchronous relay cell frame 403 is transmitted, the RS needs to acquire synchronization and control information by receiving a Broadcast Channel (BCH) from the serving cell frame 401. To this end, the RS sends the relay cell frame 403 by delaying it by more than BCH interval from the serving cell frame 401. The BCH includes a preamble signal and common control information.

If there is user traffic for the relay in the serving cell frame 401, the RS needs to receive the user traffic. In this case, since the RS needs to receive data burst following the BCH interval of the serving cell frame 401, the relay cell frame 403 can be delayed by more than BCH interval.

Because the serving cell frame 401 and the relay cell frame 403 are asynchronously transmitted using the same frequency band, if different transmission (Tx) modes (UL and DL) are overlapped, interference occurs to adjacent signals. Specifically, when the UL interval of the serving cell frame 403 and the DL interval of the relay cell frame 403, or the UL interval of the relay cell frame 403 and the DL interval of the serving cell frame 401 are overlapped, each frame is subject to the interference of great received power strength.

To cancel the interference, the RS makes the relay cell frame 403 of intervals 411, 413, and 415 null, where the serving cell frame 401 and the relay cell frame 403 are overlapped in the different modes.

If the RS further delays the relay cell frame 403 from the start point of the UL interval of the serving cell frame 401 and transmits the delayed relay cell frame 405, the entire UL interval of the relay cell frame 405 overlaps with the DL interval of the serving cell frame 401. Thus, all of the UL intervals of the relay cell frame 405 are null. That is, the RS cannot receive the UL signal from the MS using the relay cell frame 405.

As a result, the RS cannot delay and transmit the relay cell frame 403 further from the start point of the UL interval of the serving cell frame 401.

In other words, the RS needs to have the transmission start timing of the relay cell frame between the BCH interval of the serving cell frame 401 and the start point of the UL interval of the serving cell frame 401 within the serving cell frame interval.

As described above, the RS delays and asynchronously transmits the relay cell frame 403 from the serving cell frame 401, so as to address the RF isolation problem occurring when performing the transparent relay using one frequency band. In doing so, when the different Tx modes (UL and DL) are overlapped, the RS cancels the interference by making the overlapping interval of the relay cell frame 401 null.

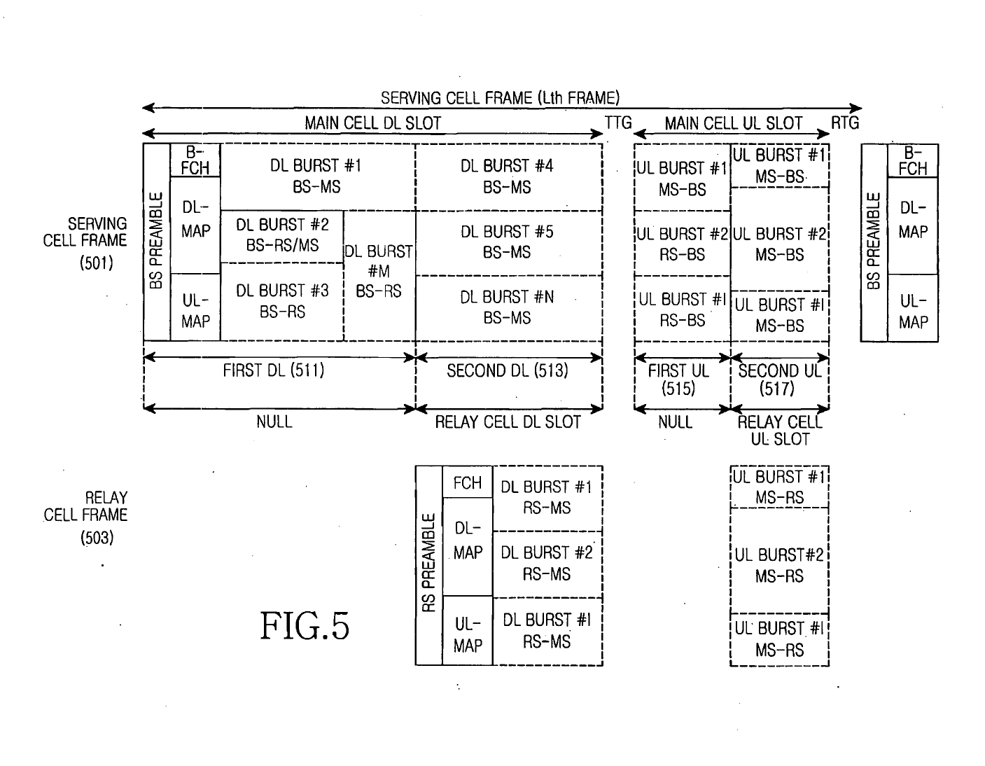

After receiving the signal in the serving cell frame 401, the RS needs to send the relay cell frame 403. Hence, to cancel the interference far more efficiently, the RS can send the signal by constructing a frame as shown in FIG. 5.

FIG. 5 shows a serving cell frame and a relay cell frame which support asynchronous timing using a space division multiplexing according to the present invention. The frames are divided to a DL subframe and a UL subframe. The UL/DL subframes are subdivided to first intervals 511 and 515, and second intervals 513 and 517.

As for the DL subframe, the serving cell frame 501 includes a preamble, control information, and traffic which are transmitted from the BS to the MS and the RS in the first DL interval 511, and user traffic which is transmitted from the BS to the MS receiving the serving cell service through the direct link within the second DL interval 513.

The relay cell frame 503 is null because the RS has to receive the DL signal from the BS during the first DL interval 511. If the serving cell frame 501 overlaps with a UL interval of a previous relay cell frame during the first DL interval 511, the previous relay cell frame makes the overlapping region null.

The relay cell frame 503 includes a preamble, control information, and user traffic which are transmitted from the RS to the MS in the relay link during the second DL interval 513. During the second DL interval 513, the serving cell frame 501 and the relay cell frame 503 are constructed through the space division multiplex. The RS sends the relay cell frame 503 according to the transmission timing provided from the BS in the second DL interval 513. That is, the RS delays and transmits the relay cell frame 503 by the first DL interval 511.

As for the UL subframe, the serving cell frame 501 includes a UL signal which is transmitted from the RS or the MS to the BS in the direct link during the first UL interval 515. Also, the serving cell frame 501 includes a UL signal which is transmitted from the MS to the BS in the direct link during the second UL interval 517.

The relay cell frame 503 sends a UL signal to the BS during the first UL interval 515. In FIG. 5, the first UL interval 515 of the relay cell frame 503 is indicated as null. The relay cell frame 503 includes a UL signal which is transmitted from the MS to the RS in the relay link during the second UL interval 517. At this time, the serving cell frame 501 and the relay cell frame 503 of the second UL interval 517 are constructed through the spatial multiplexing. If the first UL interval 517 has a region where the DL interval of the relay cell frame 503 and the UL interval of the serving cell frame 501 are overlapping, the relay cell frame 503 makes the overlapping region null.

The first DL interval and the first UL interval are serviced to the RS or the MS which communicates with the BS through the direct link. In contrast, the second DL interval and the second UL interval are serviced to the MS which communicates with the BS through the direct link or the relay link.

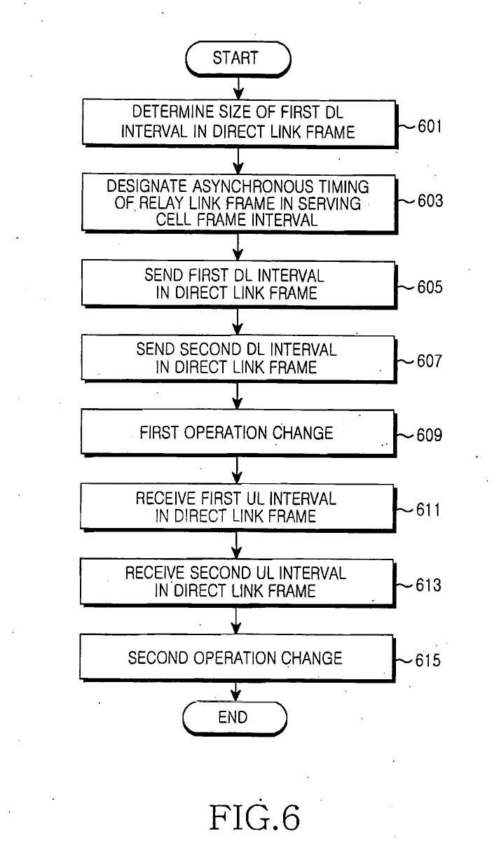

FIG. 6 shows an operation of a BS for supporting the asynchronous relay using the space division multiplexing according to the present invention. The following explanation describes a scheduling method of a BS to transmit the serving cell frame and the relay cell frame by asynchronously dividing their intervals as shown in FIG. 5.

Referring to FIG. 6, the BS determines a size of the first DL interval in the DL interval of the serving cell frame based on the preamble, the common control information, and the traffic volume to be transmitted to the RS in step 601.

In step 603, the BS determines the start point of the relay cell frame by taking account of the determined size of the first DL interval and the transmission delay, and sends it to the RS through a control channel. That is, the RS has to receive not only the preamble and the control information but also the traffic to be used, from the BS. Hence, the BS determines the start point of the relay cell frame so the RS could receive the preamble, the control information, and the traffic. The BS governs the operation of the RS through the control channel of the BS-RS link.

Upon determining the transmission interval of the serving cell frame and the transmission interval of the relay cell frame, the BS sends the preamble signal, the common control information, and the traffic to the RS and the MSs through the direct link in the first DL interval in step 605. The RS receives the preamble signal, the common control information, and the traffic signal from the BS in the first DL interval of the serving cell frame of the direct link.

After sending the signal in the first DL interval, the BS sends the user traffic to the MSs in the direct link of the second DL interval in step 607. In doing so, the RS sends the DL signal of the relay cell frame by changing its operation according to the transmission timing determined in step 603. The serving cell frame of the BS and the relay cell frame of the RS are spatial-multiplexed to use the same frequency band.

Next, in step 609, the BS performs a first operation change from the Tx mode to the reception (Rx) mode.

After the first operation change, the BS receives a UL signal from the RS or the MSs in the direct link of the first UL interval in step 611. In doing so, the RS sends the UL signal to the BS in the serving cell frame of the direct link.

After receiving the signal in the first UL interval, the BS receives a UL signal from the MSs through the direct link of the second UL interval in step 613. At this time, the RS receives the UL signal from the MSs through the relay cell frame. The serving cell frame of the BS and the relay cell frame of the RS are spatial-multiplexed to use the same frequency band.

Next, the BS performs a second operation change from the Rx mode to the Tx mode in step 615 and then terminates the algorithm.

The aforementioned method simultaneously provides the direct link service and the relay link service that are spatial-multiplexed in the interval, excluding the common interval (the interval serviced to the MS having the direct link and to the RS), of the serving cell frame using one frequency band. However, when the MS belonging to the service coverage of the BS and the MS serviced via the RS are located adjacent to each other, the spatial-multiplexed signal may act as interference to the MSs.

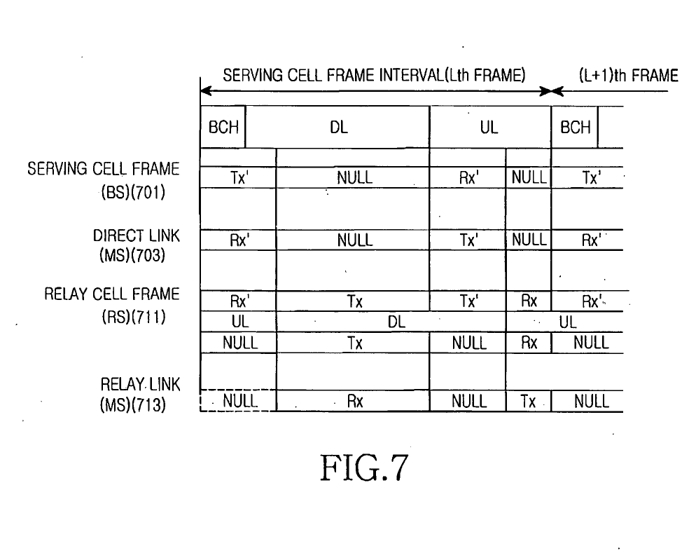

The intracell interference can be rejected through the time division multiplexing as shown in FIG. 7.

FIG. 7 shows a serving cell frame and a relay cell frame for supporting the asynchronous relay using the time division multiplexing according to the present invention. The relay cell frame 711 is null in an interval transmitting the serving cell frame 701. In an interval transmitting the relay cell frame 711, the serving cell frame 701 is null.

To ease the understanding, Tx′ and Rx′ in the serving cell frame (BS) 701, the direct link (MS) 703, and the relay cell frame (RS) 711 indicate data transmission in the direct link, and Tx and Rx in the relay cell frame (RS) 711 and the relay link (RS) 713 indicate data transmission in the relay link.

Since the serving cell frame 701 and the relay cell frame 711 are asynchronously transmitted, when it is the transmission timing of the relay cell frame 711 while the DL signal of the serving cell frame 701 is sent in the direct link, the DL signal of the relay cell frame 711 is transmitted. In more detail, since the serving cell frame 701 and the relay cell frame 711 use the same resource, at the transmission time of the relay cell frame 711, in order to avoid the interference, the serving cell frame 701 aborts the transmission. In doing so, the intervals providing the serving cell service in the direct link to the RS as well as the MS are reduced, and thus it is hard to efficiently provide wireless access communication service.

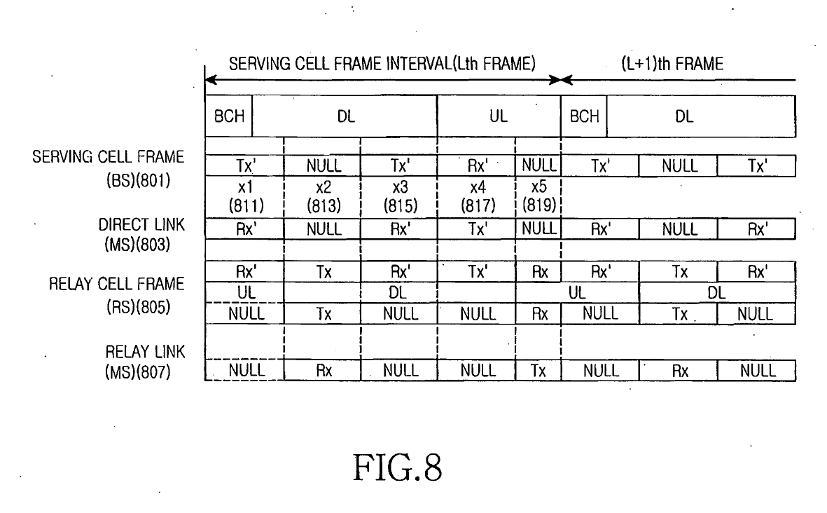

Thus, by ensuring an additional DL interval of the serving cell frame in each frame as shown in FIG. 8, the serving cell frame 701 and the relay cell frame 711 should be provided at a certain rate.

FIG. 8 shows the serving cell frame 801 which is divided to time slots to maintain UL/DL transmission efficiency of the serving cell frame according to the present invention. In the following explanation, the interval is divided to five time slots by way of example.

The serving cell frame 801 and the relay cell frame 805 are transmitted by dividing the serving cell frame interval to five time slots x1, x2, x3, x4, and x5 by taking into account a frame length, the ratio of the DL interval to the UL interval in the serving cell frame 801, and the ratio of the interval transmitted from the BS to the RS to the interval transmitted to the MS in the direct link of the serving cell frame 801.

In the interval x1 811, the BS sends BCH and DL signal to the RS or the MS in the direct link of the serving cell frame 801. The RS receives the BCH and the DL signal destined for the RS.

In the interval x2 813, the RS sends DL signal to the MSs in the relay link of the relay cell frame 805. The serving cell frame 801 is null.

In the interval x3 815, the BS sends DL signal to the MSs in the direct link of the serving cell frame 801. The DL interval of the relay cell frame 805 is null.

In the interval 4x 817, the MS or the RS sends UL signal to the BS in the direct link of the serving cell frame 801. At this time, the RS sends the UL signal to the BS. Accordingly, the DL interval of the relay cell frame 805 is null.

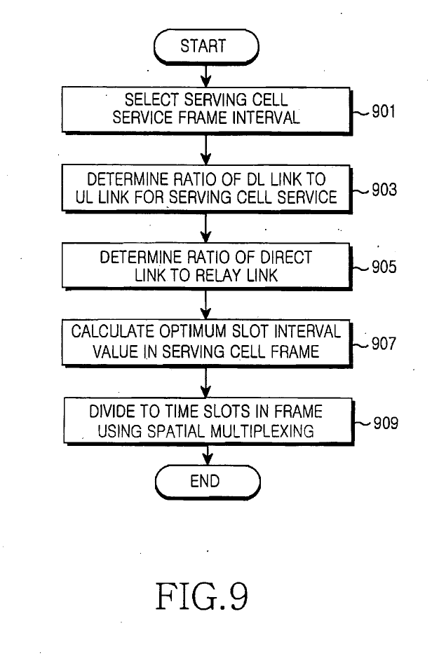

In the interval x5 819, the MS sends UL signal to the RS in the relay link of the relay cell frame 805. The serving cell frame 801 is null. The five time slots are divided as shown in FIG. 9.

Tx′ and Rx′ in the serving cell frame (BS) 801, the direct link (MS) 803, and the relay cell frame (RS) 805 indicate data transmission in the direct link, and Tx and Rx in the relay cell frame (RS) 805 and the relay link (MS) 807 indicate data transmission in the relay link.

FIG. 9 shows an optimum time slot selection procedure when constructing the serving cell frame by dividing to time slots according to the present invention. The BS selects the serving cell frame interval (a) to divide the serving cell frame to five time slots in step 901. That is, the BS checks the frame length.

After selecting the serving cell frame interval, the BS determines the ratio (b) of the DL interval to the UL interval in the serving cell frame to provide the serving cell service in step 903.

In step 905, the BS determines a ratio (c) of the service interval through the direct link to the service interval through the relay link in the serving cell frame.

Upon determining all of a, b, and c, the BS checks the number of divided time slots and calculates an optimum slot interval value by applying a, b, c, and the number of the time slots to Equation (1).

$$\begin{matrix}{x}_{1} = \frac{a \times c}{( b + 1 ) ( c + 1 )} \\ {x}_{2} = \frac{a \times b}{( b + 1 ) ( c + 1 )} \\ {x}_{3} = \frac{( b - 1 ) \times a \times c}{( b + 1 ) ( c + 1 )} \\ {x}_{4} = \frac{a \times c}{( b + 1 ) ( c + 1 )} \\ {x}_{5} = \frac{a}{( b + 1 ) ( c + 1 )}\end{matrix} \qquad ( 1 )$$

In Equation (1), x₁, x₂, x₃, x₄, and x₅ denote the time slots, a denotes the serving cell frame interval, and b denotes the ratio of the UL interval to the DL interval in the serving cell frame. c denotes the ratio of the service interval through the direct link and the service interval through the relay link in the serving cell frame.

Equation (1) has the same relations as in Equation 2, and accordingly, the optimum interval value of each time slots can be acquired using a, b, and c.
x₁+x₂+x₃+x₄+x₅=a x₁+x₃=bx₄x₂=bx₅x₁+x₂+x₃=x₂+x₃+x₄x₁+x₃=Cx₂ (2)

In Equation (2), x₁, x₂, x₃, x₄, and x₅ denote the time slots, a denotes the serving cell frame interval, and b denotes the ratio of the DL interval to the UL interval in the serving cell frame. c denotes the ratio of the service interval through the direct link and the service interval through the relay link in the serving cell frame.

Since the serving cell frame is divided to five time slots, the time slot interval value can be acquired using the five equations of Equation 5.

Upon calculating the time slot value, the BS divides the serving cell frame according to the acquired time slot interval value in step 909. Next, the BS terminates the algorithm.

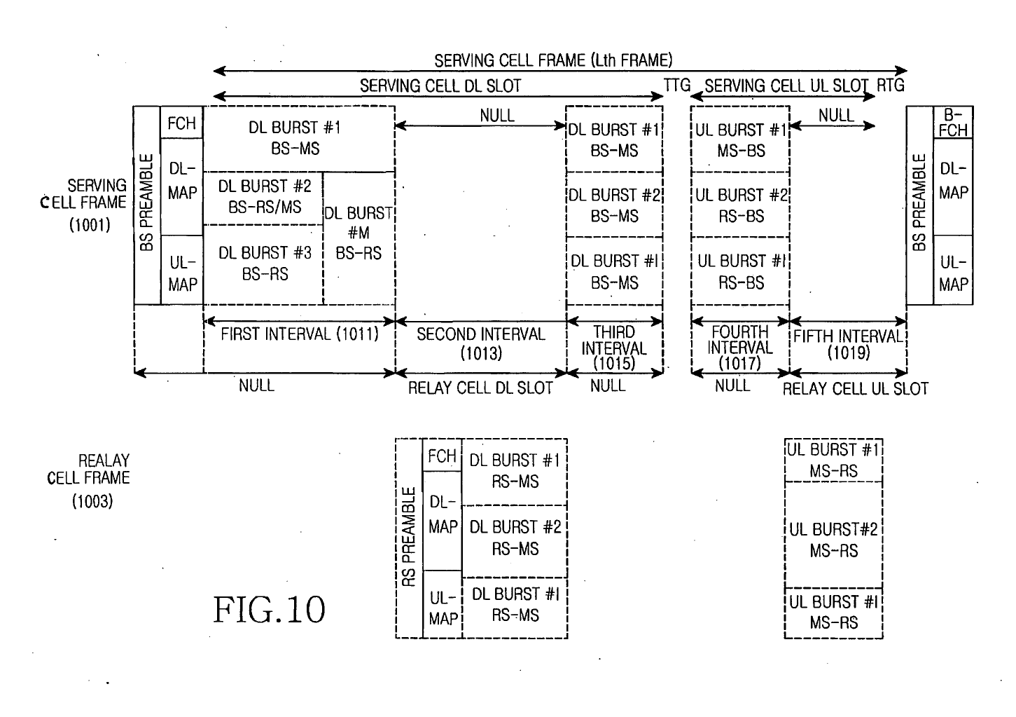

FIG. 10 shows a serving cell frame and a relay cell frame for supporting the asynchronous relay by dividing to time slots according to the present invention. The BS efficiently provides the serving cell service using five time slot intervals divided using the length of the serving cell frame interval, the ratio of the DL interval to the UL interval in the serving cell frame, an the ratio of the service interval through the direct link to the service interval through the relay link in the serving cell frame.

In the first interval 1011, the BS sends BCH and DL signal to the RS or the MS in the direct link of the serving cell frame 1001. The RS receives the BCH and the DL signal destined for the RS.

In the second interval 1013, the RS sends DL signal to the MSs in the relay link of the relay cell frame 1003. At this time, the serving cell frame 1001 is null.

In the third interval 1015, the BS sends DL signal to the MSs in the direct link of the serving cell frame 1001. At this time, the relay cell frame 1003 is null.

In the fourth interval 1017, the MS or the RS sends UL signal to the BS in the direct link of the serving cell frame 1001. The RS sends the DL signal to the BS. Hence, the DL interval of the relay cell frame 1003 is null.

In the fifth interval 1019, the MS sends UL signal to the RS in the relay link of the relay cell frame 1003. At this time, the serving cell frame 1001 is null.

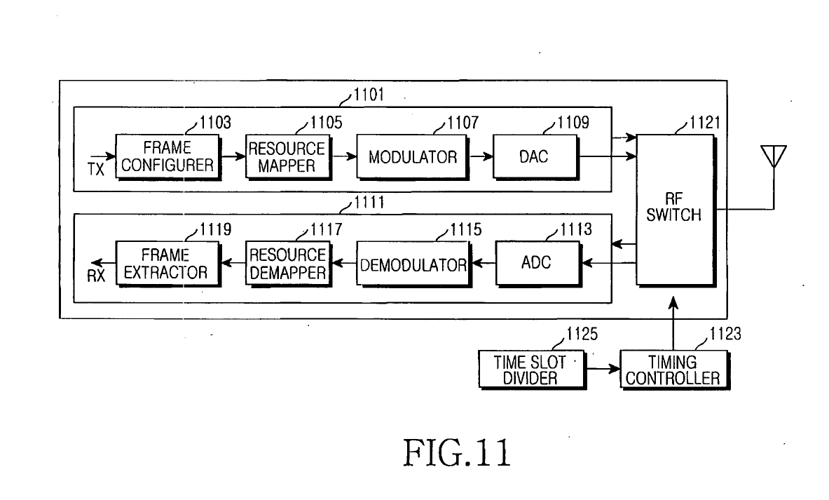

FIG. 11 shows a BS which supports the asynchronous timing according to the present invention. In the following explanation, a TDD BS is described. The BS includes a transmitter 1101, a receiver 1111, a Radio Frequency (RF) switch 1211, a timing controller 1123, and a time slot divider 1125.

The transmitter 1101 includes a frame constructor 1103, a resource mapper 1105, a modulator 1107, and a Digital/Analog Converter (DAC) 1109.

The frame constructor 1103 generates subframes according to the respective destinations of data provided from an upper stage. For instance, a BS-MS subframe is constructed using data to be transmitted to an MS connected in the direct link, and a BS-RS subframe is constructed using data to be transmitted to the RS.

The resource mapper 1105 allocates the subframes provided from the frame constructor 1103, to bursts of the links allocated to the respective subframes, and outputs the allocated subframes.

The modulator 1107 modulates the subframes allocated to the respective link bursts at the resource mapper 1105, according to a predefined modulation scheme. The DAC 1109 converts the digital signal modulated at the modulator 1107 to an analog signal, up-converts the analog signal to an RF signal, and sends the RF signal to the MS or the RS via an antenna under the control of the RF switch 112 1.

The receiver 1111 includes an Analog/Digital Converter (ADC) 1113, a demodulator 1115, a resource demapper 1117, and a frame extractor 1119.

The ADC 1113 down-converts a signal received over the antenna and converts an analog signal transformed to a baseband signal, to a digital signal under the control of the RF switch 112 1.

The demodulator 1115 demodulates the digital signal provided from the ADC 1113 according to the corresponding demodulation scheme, and outputs the demodulated signal.

The resource demapper 1117 extracts the actual subframes allocated to the respective link bursts provided from the demodulator 1115.

The frame extractor 1119 extracts a subframe corresponding to the receiver 1111 from the subframes fed from the resource demapper 1117. For instance, the frame extractor 1119 extracts the BS-MS subframe and the BS-RS subframe.

The RF switch 1121 connects the transmitter 1101 and the receiver 1111 to the antenna depending on the Tx band and the Rx band of the frame under the control of the timing controller 1123.

The timing controller 1123 generates frame timing signals of the BS and the RS for the asynchronous transparent relay using one frequency band as shown in FIGS. 5 and 10, and provides the generated frame timing signals to the BS and the RS. When using the time division multiplexing as shown in FIG. 10, the timing controller 1123 receives the time slot interval values generated at the time slot divider 1125 and generates a timing signal to transmit the serving cell frame by dividing to the time slots. The time slot divider 1125 calculates the time slot interval values based on Equation (1).

As set forth above, in a multihop relay BWA communication system, a serving cell service is relayed transparently and asynchronously using one frequency band. Hence, serving cell service coverage expansion and backward compatibility are achieved and a frame is constructed by selecting an optimum frame interval according to system information of the serving cell service. Therefore, efficient wireless access service can be provided.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A subframe construction method of supporting a relay service using one frequency band in a wireless communication system, the method comprising:
constructing a direct link subframe to communicate in a direct link between a Base Station (BS) and a Relay Station (RS) or a Mobile Station (MS) during a first interval of the subframe; and
constructing a direct link subframe to communicate in a direct link between the BS and an MS, and a relay link subframe to communicate in a relay link between the RS and an MS during a second interval of the subframe.

2. The subframe construction method of claim 1, wherein the direct link subframe and the relay link subframe in the second interval are constructed through a spatial multiplexing in the same frequency band.

3. The subframe construction method of claim 1, wherein the relay link subframe in the second interval designates a start point in asynchrony to the direct link subframe.

4. The subframe construction method of claim 3, wherein, when the direct link frame and the relay link frame in a certain interval have different transmission (Tx) modes, the relay link frame of the certain interval is null.

5. A method of supporting a relay service using one frequency band at a Base Station (BS) in a wireless communication system, the method comprising:
setting a direct link frame interval for providing service to a Relay Station (RS) or a Mobile Station (MS) in a direct link;
designating a start point of a relay link frame for providing service between the RS and the MS according to a Broadcast Channel (BCH) transmission interval in the direct link frame;
sending start point information of the relay link frame to the RS; and
communicating with one of the RS and an MS according to the direct link frame construction scheme.

6. The method of claim 5, wherein the start point of the relay link frame is between an end point of the BCH of the direct link frame and a start point of an uplink (UL) transmission interval of the direct link frame.

7. The method of claim 5, wherein the BCH comprises a preamble signal and control information.

8. The method of claim 5, wherein the relay link frame is constructed through a spatial multiplexing in the same frequency band as the direct link frame.

9. The method of claim 5, wherein the direct link frame comprises a first interval for communicating with one of the RS and an MS in the direct link, and a second interval for communicating with the MS in the direct link.

10. A frame construction method of supporting a relay service using one frequency band in a wireless communication system, the method comprising:
constructing a direct link subframe for a Base Station (BS) to send a signal to a Relay Station (RS) or a Mobile Station (MS) in a direct link during a first interval of the frame;
constructing a relay link subframe for the RS to send a signal to the MS in a relay link during a second interval of the frame;
constructing a direct link subframe for the BS to send a signal to the MS in a direct link during a third interval of the frame;
constructing a direct link subframe for one of the RS and the MS to send a signal to the BS in a direct link during a fourth interval of the frame; and
constructing a relay link subframe for the MS to send a signal to the RS in a relay link during a fifth interval of the frame.

11. The frame construction method of claim 10, wherein the direct link subframe is null during the second interval and the fourth interval.

12. The frame construction method of claim 10, wherein the relay link subframe is null during the first interval, the third interval, and the fifth interval.

13. A method of supporting a relay service using one frequency band at a Base Station (BS) of a wireless communication system, the method comprising:
setting a direct link frame interval for communicating with a Relay Station (RS) or a Mobile Station (MS) in a direct link;
setting a relay link frame interval for communicating between the RS and the MS in relay link;
constructing a frame by time-dividing the frame interval to a certain number of intervals and allocating the intervals to a direct link frame or a relay link frame; and
sending the frame construction information to the RS and the MS.

14. The method of claim 13, wherein the direct link frame interval is a length of the frame.

15. The method of claim 13, wherein the frame time-dividing step comprises: determining a first ratio of an uplink (UL) interval to a downlink (DL) interval and ratio of a relay link service interval to a direct link service interval within the frame interval;
determining a length of each interval for dividing the frame to the certain number of intervals using the frame interval, the first ratio, and the second ratio; and
time-dividing the frame interval based on the length of each interval.

16. The method of claim 15, wherein the length of each interval is calculated base on the equation:
$$\begin{matrix}{x}_{1} = \frac{a \times c}{( b + 1 ) ( c + 1 )} \\ {x}_{2} = \frac{a \times b}{( b + 1 ) ( c + 1 )} \\ {x}_{3} = \frac{( b - 1 ) \times a \times c}{( b + 1 ) ( c + 1 )} \\ {x}_{4} = \frac{a \times c}{( b + 1 ) ( c + 1 )} \\ {x}_{5} = \frac{a}{( b + 1 ) ( c + 1 )}\end{matrix}$$
where x₁, X₂, X₃, x₄, and x₅ denote a length of the respective intervals, a denotes a direct link frame interval, b denotes a ratio of the UL interval to the DL interval, and c denotes a ratio of the direct link frame interval to the relay link frame interval.

17. The method of claim 13, wherein the frame constructing step comprises:
making the relay link frame null in an interval allocated to the direct link frame; and
making the direct link frame null in an interval allocated to the relay link frame.

18. The method of claim 13, wherein the frame constructing step comprises:
when dividing the frame to five intervals, constructing a direct link subframe for the BS to send a signal to one of the RS and the MS in a direct link during a first interval;
constructing a relay link subframe for the RS to send a signal to the MS in a relay link during a second interval;
constructing a direct link subframe for the BS to send a signal to the MS in a direct link during a third interval;
constructing a direct link subframe for one of the RS and the MS to send a signal to the BS in a direct link during a fourth interval; and
constructing a relay link subframe for the MS to send a signal to the RS in a relay link during a fifth interval.

19. An apparatus for supporting a relay service using one frequency band at a Base Station (BS) in a wireless communication system, comprising:
a time slot divider for calculating a length of a time slot according to a frame length, a ratio of an uplink (UL) interval to a downlink (DL) interval, a ratio of a direct link service interval to a relay link service interval, and a number of time slots;
a timing controller for providing a timing signal to transmit and receive a signal according to the calculated length of the time slot;
a transmitter for sending a signal of a corresponding frequency band according to the timing signal; and
a receiver for receiving a signal of a corresponding frequency band according to the timing signal.

20. The apparatus of claim 19, wherein the time slot divider is comprising:
means for checking a ratio of a direct link service interval to a relay link service interval within the direct link frame and the number of time slots to be divided, and
means for calculating the length of the time slot based on the frame length, the ratio of the UL interval to the DL interval, the ratio of the direct link service interval to the relay link service interval, and the number of the time slots.

21. The apparatus of claim 20, wherein the time slot divider calculates the length of the time slots of each interval based on the equation:
$$\begin{matrix}{x}_{1} = \frac{a \times c}{( b + 1 ) ( c + 1 )} \\ {x}_{2} = \frac{a \times b}{( b + 1 ) ( c + 1 )} \\ {x}_{3} = \frac{( b - 1 ) \times a \times c}{( b + 1 ) ( c + 1 )} \\ {x}_{4} = \frac{a \times c}{( b + 1 ) ( c + 1 )} \\ {x}_{5} = \frac{a}{( b + 1 ) ( c + 1 )}\end{matrix}$$
where x₁, X₂, x₃, x₄, and x₅ denote a length of the respective intervals, a denotes a direct link frame interval, b denotes the ratio of the UL interval to the DL interval, and c denotes the ratio of the direct link frame interval to the relay link frame interval.

22. The apparatus of claim 19, wherein the transmitter comprises:
a frame constructor for constructing a frame using subframes of signals to be transmitted; and
a resource mapper for mapping the subframes of the constructed frame to resources allocated to bursts of the respective links.

23. The apparatus of claim 19, wherein the receiver comprises:
a resource demapper for extracting subframes allocated to the respective bursts of the received signals; and
a frame extractor for extracting subframes of the links from the extracted subframes.

24. A wireless communication system, comprising:
means for constructing a direct link subframe to communicate in a direct link between a Base Station (BS) and a Relay Station (RS) or a Mobile Station (MS) during a first interval of the subframe; and
means for constructing a direct link subframe to communicate in a direct link between the BS and an MS, and a relay link subframe to communicate in a relay link between the RS and an MS during a second interval of the subframe.

25. The wireless communication system of claim 24, wherein the direct link subframe and the relay link subframe in the second interval are constructed through a spatial multiplexing in the same frequency band.

26. A Base Station (BS) in a wireless communication system, comprising:
means for setting a direct link frame interval for providing service to a Relay Station (RS) or a Mobile Station (MS) in a direct link;
means for designating a start point of a relay link frame for providing service between the RS and the MS according to a Broadcast Channel (BCH) transmission interval in the direct link frame;
means for sending start point information of the relay link frame to the RS; and
means for communicating with one of the RS and an MS according to the direct link frame construction scheme.

27. A wireless communication system, comprising:
means for constructing a direct link subframe for a Base Station (BS) to send a signal to a Relay Station (RS) or a Mobile Station (MS) in a direct link during a first interval of the frame;
means for constructing a relay link subframe for the RS to send a signal to the MS in a relay link during a second interval of the frame;
means for constructing a direct link subframe for the BS to send a signal to the MS in a direct link during a third interval of the frame;
means for constructing a direct link subframe for one of the RS and the MS to send a signal to the BS in a direct link during a fourth interval of the frame; and
means for constructing a relay link subframe for the MS to send a signal to the RS in a relay link during a fifth interval of the frame.

28. A Base Station (BS) of a wireless communication system, comprising:
means for setting a direct link frame interval for communicating with a Relay Station (RS) or a Mobile Station (MS) in a direct link;
means for setting a relay link frame interval for communicating between the RS and the MS in relay link;
means for constructing a frame by time-dividing the frame interval to a certain number of intervals and allocating the intervals to a direct link frame or a relay link frame; and
means for sending the frame construction information to the RS and the MS.
